(19) United States
(12) Patent Application Publication
(10) Pub. No.: US 2011/0136929 A1
(43) Pub. Date: Jun. 9, 2011

(54) TRAPPING GLUCOSE PROBE IN PORES OF POLYMER

(76) Inventors: Pei Yong Edwin Chow, Singapore (SG); Jackie Y. Ying, Singapore (SG)

(21) Appl. No.: 13/002,800

(22) PCT Filed: Jul. 9, 2009
(86) PCT No.: PCT/SG09/00245

§ 371 Date: Jan. 6, 2011

Related U.S. Application Data
(60) Provisional application No. 61/129,646, filed on Jul. 9, 2008.

(51) Int. Cl. C08J 9/00; C08L 33/10

(52) U.S. Cl. 521/105; 521/149

(57) ABSTRACT

A polymer matrix defining pores is formed by polymerizing polymer precursors in a precursor solution. The precursor solution comprises a bicontinuous microemulsion of a first fluid in a first continuous phase and a second fluid in a second continuous phase. The first fluid comprises the polymer precursors. The second fluid comprises the glucose probe. Some internal pores are connected to surface pores in the matrix through openings sized to allow passage of glucose molecules but restrict passage of the glucose probe. As the glucose probe is dispersed in the precursor solution prior to polymerization, some glucose probe molecules are trapped in the internal pores after polymerization. The formed polymer may be used in an ophthalmic device such as contact lens, for detecting the presence of glucose in an ocular fluid.

### CROSS-REFERENCE TO RELATED APPLICATION

This application claims the benefit of U.S. provisional application No. 61/129,646, filed Jul. 9, 2008, the entire contents of which are incorporated herein by reference.

### FIELD OF THE INVENTION

The present invention relates generally to methods and products for monitoring glucose level, and more specifically to methods and products for monitoring glucose level with a glucose probe incorporated into a polymer.

### BACKGROUND OF THE INVENTION

Glucose-sensing contact lenses provide a promising new technique for monitoring glucose levels, such as in patients who suffer from diabetes. One technique is to load a boronic acid into the pores of a porous contact lens material, by soaking the material in a solution of the boronic acid. When the loaded contact lens is worn by a user, the tear of the user comes into contact with the contact lens. In the presence of glucose, the boronic acid changes its electronic and geometric properties, which induces a change in its fluorescence spectrum. When there is an elevated concentration of glucose in the user's tear, it is possible to visually detect the spectral change (in color or intensity) in the contact lens worn by the user. However, it has been reported that such contact lenses produced poor glucose responses. When the probe is not attached to the pore surface, it can leach out during use, which leads to reduced detection sensitivity. Bonding the probe molecules to the polymer may prevent leaching, but can lead to other undesirable effects such as alteration of the lens material's optical and biological properties. Chemical bonding between the probe and the polymer may also change the response mechanism of the probe to glucose, thus leading to complication and unpredictable performance.

### SUMMARY OF THE INVENTION

The inventors of this invention have discovered that a glucose probe, such as boronic acid probe, can be trapped in pores of a porous polymer during formation of the polymer, without bonding the probe to the polymer. When internal pores in the polymer are connected with one another and to surface pores, glucose can travel through the connected pores to interact with the probe in the pores during use. To prevent leaching of the probe, the pores can be connected through openings sized to restrict passage of the probe through the openings.

When the pores and connecting openings are properly sized to restrict motion of the probe, such as when the pores are in the range of about 20 to about 80 nm and the openings are in the range of about 5 to about 20 nm, the emission intensity of the probe in the presence of glucose can also be enhanced, as compared to unrestricted probes dispersed in solution.

Accordingly, in an aspect of the present invention, there is provided a method of forming a polymer for use in an ophthalmic device. In this method, polymer precursors in a precursor solution are polymerized to form a polymer matrix defining internal pores and surface pores. The precursor solution comprises a bicontinuous microemulsion of a first fluid in a first continuous phase and a second fluid in a second continuous phase. The first fluid comprises the polymer precursors. A plurality of the internal pores are connected to surface pores through openings sized to allow passage of glucose molecules but restrict passage of a glucose probe. Molecules of the glucose-probe are dispersed in the second fluid prior to polymerization, thus, after polymerization, a portion of the glucose-probe molecules are trapped in the internal pores. The internal pores may have an average pore size from about 20 to 80 nm. The openings may be from about 5 to about 10 nm in size. The glucose probe may comprise a boronic acid, which may have the formula of R—B(OH)₂, where R is one of alkyl, alkenyl, cycloalkyl, cycloalkenyl, alkoxyalkyl, alkoxyalkenyl, and aryl arylakyl. The boronic acid may comprise 1,3-diphenylprop-2-en-1-one or 1,5-diphenylpenta-2,4-dien-1-one. The boronic acid may have a concentration of about 0.1 to about 5 wt % in the second fluid. The polymer precursors may comprise a monomer and a surfactant copolymerizable with the monomer to form the polymer matrix, and the second fluid may comprise water.

In another aspect of the present invention, there is provided a polymer for use in an ophthalmic device. The polymer comprises a polymer matrix defining internal pores and surface pores, a plurality of the internal pores connected to surface pores through openings sized to allow passage of glucose molecules but restrict passage of a glucose probe; and molecules of the glucose probe, trapped inside the internal pores and in a sufficient amount for generating a detectable spectral response when the polymer is in contact with an ocular fluid. The pores defined by the polymer matrix may have an average pore size from about 20 to 80 nm. The openings may be from about 5 to about 10 nm in size. The glucose probe may comprise a boronic acid, which boronic acid may have the formula of R—B(OH)₂, where R is one of alkyl, alkenyl, cycloalkyl, cycloalkenyl, alkoxyalkyl, alkoxyalkenyl, and aryl arylakyl. The boronic acid may comprise 1,3-diphenylprop-2-en-1-one or 1,5-diphenylpenta-2,4-dien-1-one. The boronic acid may have a density of about 0.1 to about 5 wt % in the polymer.

In a further aspect of the present invention, there is provided an ophthalmic device which comprises a polymer formed according to any of the methods described herein. The ophthalmic device may comprise a contact lens.

In another aspect of the present invention, there is provided a precursor solution for forming a polymer. The precursor solution comprises a bicontinuous microemulsion of a first fluid in a first continuous phase and a second fluid in a second continuous phase, the first fluid comprising polymer precursors polymerizable to form a polymer matrix, the second fluid comprising a glucose probe, the bicontinuous microemulsion being selected so that upon polymerization of the polymer precursors, the polymer matrix formed from the precursor solution defines internal pores and surface pores, and molecules of the glucose probe are trapped in the internal pores connected to surface pores through openings sized to allow passage of glucose molecules but restrict passage of the molecules of the glucose probe therethrough.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic perspective view of a contact lens, exemplary of an embodiment of the present invention;

FIG. 2 is a schematic partial cross-sectional view of the contact lens of FIG. 1;

FIGS. 3 and 4 are schematic diagrams of chemical structures of exemplary boronic acids;

FIG. 5 is a schematic diagram of the structure of a bicontinuous microemulsion, exemplary of an embodiment of the present invention;

FIG. 6 is a scanning electron spectroscopic image of a cross-section of a sample polymer;

FIG. 7 is a line graph comparing the emission spectra measured from a sample boronic acid probe in different environments;

FIG. 8 is a line graph showing the change in emission spectrum measured from a sample ophthalmic polymer in the presence of glucose at different glucose concentrations;

FIG. 9 is a line graph showing the emission spectra measured from different sample ophthalmic polymers in the presence of glucose at a fixed glucose concentration;

FIG. 10 is a line diagram comparing the changes in fluorescence intensity over time measured from the samples of FIG. 9, and a comparison sample;

FIG. 11 is a line graph comparing the emission spectra measured from another sample at different glucose concentrations;

FIG. 12 is a line graph showing the emission spectra dependence on precursor solution content for different samples; and

FIG. 13 is a line diagram showing the changes in fluorescence intensity over time measured from the samples of FIG. 12;

### DETAILED DESCRIPTION

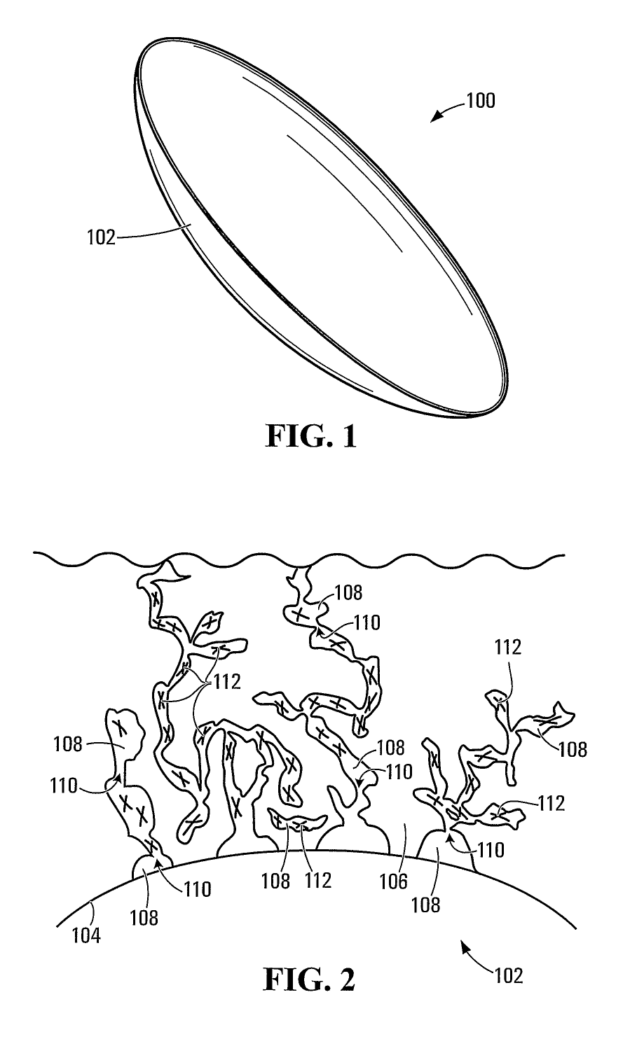

A contact lens 100 according to an exemplary embodiment of the invention is schematically illustrated in FIGS. 1 and 2. Contact lens 100 may have a normal contact lens shape and is made of a polymer 102. As better shown in FIG. 2, polymer 102 has a surface 104, which will be in contact with an ocular fluid during use. For example, surface 104 may come into contact with tear when contact lens 100 is put on the eye. Polymer 102 includes a polymer matrix 106, which defines pores 108. Pores 108 include surface pores, which are pores open to surface 104, and internal pores that are away from surface 104 and are not open to a surface directly. At least some of pores 108 are connected to one another through openings 110. Some connected pores 108 may form networks of connected pores where the pores in each network are interconnected with one another through openings or other pores. Some internal pores 108 are connected to surface pores 108 through openings 110. An internal pore 108 may be connected to a surface pore 108 directly through one or more openings 108, or indirectly through one or more other pores 108 connecting the internal pore to one or more surface pores. The (directly or indirectly) connected pores 108 are in fluid communication with one another. It is possible some internal pores 108, including a network of connected pores 108, in polymer 102 may be isolated from surface pores 108. An internal pore is isolated from surface pores when it is not connected, either directly or indirectly, to any surface pore.

The average pore sizes of pores 108 are in the nanometer range, for example, from about 20 nm to about 80 nm. The average pore size of a pore 108 refers to the average cross-sectional size of the pore 108. Pores 108 may have irregular shapes, and may have generally elongated tubular shape. The average pore size of irregular elongated pores refers to the average diameter or width of the elongated pores. The length of individual elongated pores 108 may vary and may be longer than 100 nm. The volume of an individual pore 108 can be defined by closed ends (polymer walls surrounding the pore) and by one or more openings 110 in the polymer wall. The pore sizes may be measured or estimated from an electronic cross-sectional image of the polymer material, as can be understood by those skilled in the art. An opening 110 refers to the opening in the polymer wall between two adjacent pores 108, which is substantially smaller than the average pore size. For example, an opening 110 may have a size of about 5 to about 50 nm, such as from about 5 to about 10 nm, from about 10 to about 20 nm, or from about 5 to about 20 nm. Some openings 110 are narrower than others. Some or all internal pores 108 may be connected to surface pores 108, directly or indirectly, through a narrow opening 110 sized to allow passage of glucose molecules but restrict passage of a selected glucose probe therethrough.

Molecules 112 of the selected glucose probe are dispersed and trapped inside internal pores 108 that are connected to surface pores 108 through the narrow openings 110. Some glucose probe molecules 112 may also be trapped in internal pores 108 isolated from surface pores 108. Pores 108 may also contain a fluid such as water. The glucose probe molecules 112 may be dispersed in the precursor solution for forming polymer 102, and are trapped inside these internal pores 108 during formation of the polymer. The glucose probe molecules 112 should have molecular sizes larger than the molecular sizes of glucose molecules, as otherwise it will be difficult to trap the probe molecules inside the pores and still allow the glucose molecules to travel through the pores. As the glucose molecules have molecular sizes of about 1 nm, a suitable glucose probe molecule may have, for example, a molecular size of about 5 nm or larger. Because the glucose probe molecules have a larger size, their movement and motion in pores 108 are restricted by the surrounding polymer walls and the narrow openings 110 between the pores.

Conveniently, and as can be understood, the motion of glucose probe molecules 112 are restricted inside pores 108. As the passage of the probe molecules through the narrow openings 110 are restricted, the trapped probe molecules can be retained inside the internal pores 108 during use, thus reducing or eliminating “leaching” of the probe molecules. It has been surprisingly found that when sample glucose probe molecules were restricted inside nanometer-sized pores, their spectral response to the presence of glucose was enhanced, as compared to unrestricted probes dispersed in solution (see Examples below).

In different applications, the shapes and sizes of pores 108 and openings 110 may vary, but the pores should have suitable sizes and shapes to accommodate the particular glucose probe selected for the particular application, and the openings should have suitable shapes and sizes to restrict the passage of particular glucose probe.

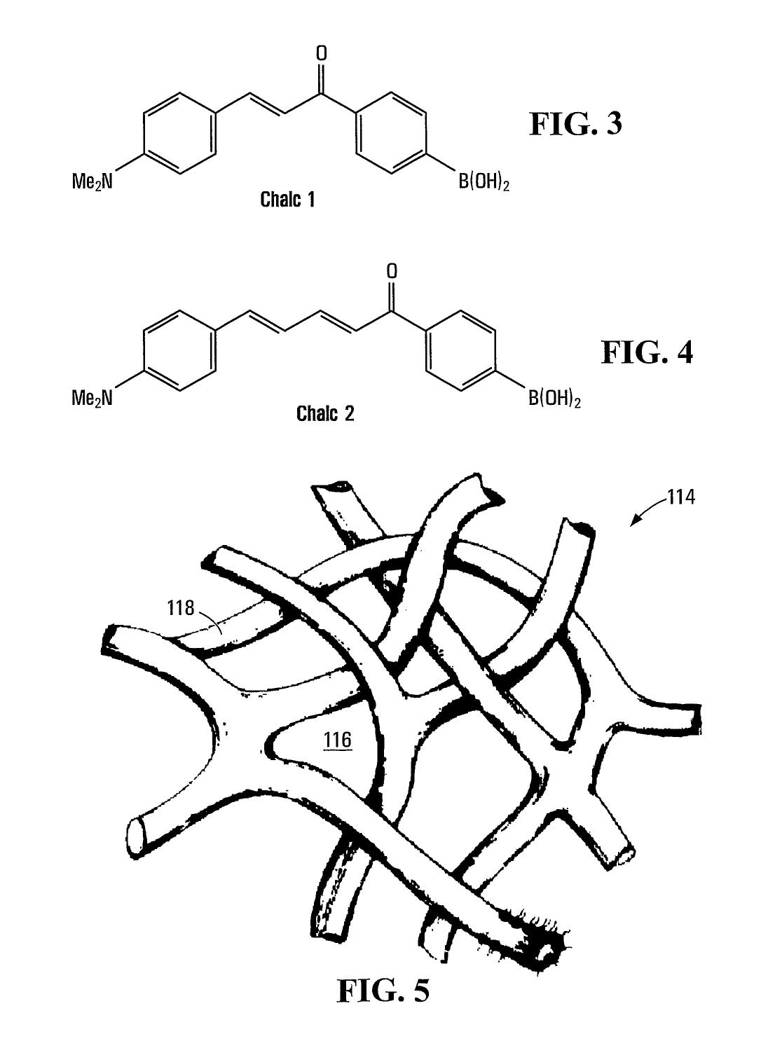

A glucose probe can be any compound that generates a detectable spectral signal, such as a change in fluorescence response, in the presence of glucose. For instance, the glucose probe may react with glucose on contact, thus forming a new compound structure which has a fluorescence spectrum different from that of the original probe molecule. A suitable glucose probe may be a boronic acid probe, such as a boronic acid-based fluorophore. For example, a boronic acid may be used. The boronic acid may have the formula of R—B(OH)₂, where R is alkyl, alkenyl, cycloalkyl, cycloalkenyl, alkoxyalkyl, alkoxyalkenyl, or aryl arylakyl. Suitable boronic acids include 1,3-diphenylprop-2-en-1-one, or alternatively expressed as 3-[4′(dimethylamino)phenyl]-1-(4″-boronophenyl)-prop-2-en-1-one (referred to as “Chalc-1”); and 1,5-diphenylpenta-2,4-dien-1-one, alternatively expressed as 5-[4″-(dimethylamino)phenyl]-1-(4′-boronophenyl)-pent-2,4-dien-1-one (referred to as Chalc-2). FIGS. 3 and 4 show the chemical structures of Chalc-1 and Chalc-2, respectively.

For example, Chalc-1 exhibits an orange-red color, a fluorescence absorption frequency at about 438 nm, and an emission frequency at about 575 nm in solution. The emission frequency will change in the presence of glucose. Some of the underlying mechanisms for the specific fluorescence response of boronic acid probes such as Chalc-1 or Chalc-2 to the presence of glucose have been discussed in the literature. It has also been found by the present inventors that the emission frequency also changes when the probe is trapped in pores that restrict its motion, as will be further discussed below.

A person skilled in the art will be able to identify other compounds or materials that will exhibit similar structural and electronic response, thus a similar reaction, to the presence of glucose.

For example, suitable glucose probes may also include a glucose sensing compound or fluorescence compound disclosed in any of the following publications: US 2007/0030443 to Chapoy et al., published Feb. 8, 2007 (hereinafter “Chapoy”); US 2007/0020182 to Geddes et al., published Jan. 25, 2007 (hereinafter “Geddes I”); Kaur et al., “Boronic acid-based fluorescence sensors for glucose monitoring,” Topics in Fluorescence Spectroscopy, 2007, vol. 11, pp. 377-397 (hereinafter “Kaur”); Badugu et al., “A glucose sensing contact lens: a new approach to non-invasive continuous physiological glucose monitoring,” Proceedings of SPIE, 2004, vol. 5317, Optical Fibers and Sensors for medical Applications IV, pp. 234-245 (hereinafter “Badugu I”); Badugu et al. “A glucose-sensing contact lens: from bench top to patient,” Current Opinion in Biotechnology, 2005, vol. 16, pp. 100-107 (hereinafter “Badugu II”); Robinson et al., “Non-invasive glucose monitoring in diabetic patients: A preliminary evaluation,” Clinical Chemistry, 1992, vol. 38, pp. 1618-1622 (hereinafter “Robinson”); and Glucose Sensing, Topics in Fluorescence Spectroscopy Vol. 11, eds. C. D. Geddes and J. R. Lakowicz, 2006, Springer (hereinafter “Geddes II”).

Suitable glucose probe may also include stilbene derivatives, such as 40-dimethylaminostilbene-4-boronic acid or 40-cyanostilbene-4-boronic acid; or anthracene derivatives, such as 9,10-bis[[N-methyl-N-(o-boronobenzyl)amino]methyl]-anthracene.

The glucose probe molecules 112 in polymer 102 are of a sufficient amount (or density) for generating a detectable spectral response when the polymer is in contact with an ocular fluid, due to the presence of glucose in the fluid. In some embodiments, the density of the glucose probe in polymer 102 may be from about 0.1 to about 5 wt % (weight percent).

As now can be understood, pores 108 may form a continuous network of connected pores 108 as long as some internal sections of the network are connected to surface pores only through narrow openings 110 that restrict passage of the glucose probe, so that the glucose probe inside these internal sections are trapped and can be retained during use. Further, some pores 108 may have larger sizes as long as some other pores 108 have smaller pore sizes that will restrict motion of the glucose probe.

For improved performance, in some applications the pores 108 in which the glucose probe is dispersed can be uniformly distributed throughout the polymer 102. In some applications, however, the pores 108 containing the glucose probe may be concentrated in a limited region in the polymer. For example, as can be appreciated, it is sufficient for detection purposes even if only a limited region of contact lens 100 (a spot) shows a detectable spectral response to the presence of glucose. The local concentrations of glucose probe in the polymer may be made different using any suitable technique known to those skilled in the art. For example, distribution of the probe molecules may be limited by diffusion after addition to the precursor solution. In a different embodiment, a contact lens may be made of different polymer materials, one of which may contain polymer 102 and another polymer may contain little or no glucose probe. If only a spot on the contact lens is doped with glucose probe, it may be convenient if the spot doped with glucose probe is visually identifiable in some cases, but this is not necessary.

The pores 108 may be initially filled with a fluid (not shown), which may include water, air, or a selected solution, prior to use.

During use, the contact lens 100 is put on the eye of a user, and comes into contact with the tear of the user. Glucose in the tear will diffuse into the pores 108 in contact lens 100. When the glucose concentration in the tear is sufficiently high, the color of contact lens 10 will visibly change due to the glucose probe's fluorescence response, indicating the presence of glucose. The fluorescence emission intensity is dependent on the concentration of glucose in the tear. Thus, the glucose level in the tear can be determined based on the detected spectral response, which will be further described below.

The glucose molecules can travel to internal pores 108 in contact lens 100 through surface pores 108 and openings 110. Yet, leaching of the trapped probe molecules 112 is prevented, as they are prevented from passing through the narrow openings 110.

Some un-trapped probe molecules may, however, exist, which may be initially dispersed in pores 108 that are connected to surface pores through large conduits. The un-trapped probe molecules may diffuse through the pores to the surface and leach out of the polymer when contact lens 100 comes into contact with a liquid. The un-trapped probe molecules may be pre-removed by rinsing the polymer after fabrication.

The glucose level may be determined after the user has been wearing the contact lens 100 for a certain “waiting” period, to allow the emission intensity to reach a stable value. This waiting period allows both redistribution of un-trapped probe molecules and glucose molecules in the contact lens, which will eventually reach a dynamic equilibrium.

After a suitable waiting period, the color of the contact lens 100 may be visually inspected and compared with a standard color chart to determine the level of glucose in the tear of the user, or the corresponding glucose level in the blood or body of the user. The glucose level may also be determined otherwise based on a pre-determined relationship between the observed spectral response and the relevant glucose levels. A suitable optical instrument may also be used to more accurately determine the spectral response and the glucose level, as can be readily appreciated by those skilled in the art.

In an exemplary embodiment, the relationship between the fluorescence responses of contact lens 100 to glucose levels may be determined prior to use, which can be readily performed by those skilled in the art. For example, a color chart correlating each possible color to a specific level of glucose may be provided. The glucose levels in the chart may indicate levels in the tear fluid, in blood, or in the body, depending on the intended use or users.

During use, the color of contact lens 100 worn by the user may be inspected such as visually by a doctor, a nurse, or the patient. The color may also be more accurately analyzed with a suitable instrument such as a color sensor, or fluorescence detector. The initial waiting period may be selected based on tests conducted with the given polymer material, or may be standardized for different materials to ensure sufficient dispersion of tear fluid regardless of the particular contact lens material used. For example, the initial waiting period may be 30 minutes long.

The observed color of contact lens 100 is then correlated with a particular glucose level, based on the pre-determined relationship described above. It can then be determined that the user has the particular level of glucose.

The color of contact lens 100 may be monitored over time when it is worn by the user. For example, it may be regularly inspected over the day. The suitable frequency of inspection may be determined, such as by a physician, depending on the particular situation.

In an exemplary embodiment, a polymer for use in contact lens 100 or other ophthalmic devices may be prepared by polymerizing polymer precursors in a precursor solution. The precursor solution may include a bicontinuous microemulsion of a first fluid in a first continuous phase and a second fluid in a second continuous phase. The polymer precursors are dispersed in the first fluid and a glucose probe is dispersed in at least the second fluid. The polymer precursors are polymerized to form a polymer matrix defining pores occupied by the second fluid.

An exemplary structure of a bicontinuous microemulsion 114 is illustrated in FIG. 5, wherein the first fluid phase is depicted as domains 116 and the second fluid phase is depicted as domains 118. Domains 116, 118 may be randomly distributed and are respectively interconnected, extending in all three dimensions. When domains 116 are polymerized, the presence of domains 118 results in the formation of connected pores filled with the second fluid. A suitable bicontinuous microemulsion may be formed by adapting and modifying an existing technique for forming polymers from bicontinuous microemulsions, such as the technique disclosed in PCT application published as WO 2006/014138 on Feb. 9, 2006, to Chow et al. (hereinafter “Chow”), the entire contents of which are incorporated herein by reference.

As the second fluid is in a continuous phase, at least some of the pores are connected to one another through openings. It also occurs that, conveniently, due to the tension created in the microemulsion during polymerization, the hollow channels connecting the pores in the formed polymer are narrowed, and the openings to these channels are smaller in size than the average pore sizes.

Conveniently, a plurality of the pores will be in fluid communication with surface pores through openings that allow passage of glucose molecules. As the glucose probe molecules are dispersed in the second fluid prior to polymerization, at least a portion of the glucose probe molecules are trapped, after polymerization, in pores that are connected to surface pores through narrow openings that restrict passage of said probe molecules therethrough, and in pores isolated from surface pores.

In the precursor solution, the first fluid may contain a hydrophobic solvent and the second fluid may contain an aqueous solution. The polymer precursors may include one or more copolymerizable monomers, and one or more surfactants copolymerizable with at least one of the monomers. The second fluid is selected so that it does not copolymerize with the polymer precursors, although some of the components in the second fluid may bond with the polymer during or after polymerization, as long as the pore structures are as described herein. Thus, at least a substantial portion of the second fluid may remain in the liquid phase after the polymer precursors in the first phase have been polymerized. As formation of the polymer is substantially limited to within the first fluid in the first phase which is continuous, the resulting polymer has a matrix structure. As the second liquid, in the second phase is not polymerized but at least largely remains in a separate, such as liquid, phase, the second liquid form pores at least some of which are connected. The pores are thus occupied by the second fluid. As can be appreciated, while the pores are occupied by the second fluid, it is possible that an unpolymerized portion of the first fluid may also be in the pores. Further, molecules such surfactant molecules in the interface regions of the two phases may also extend into the pores after polymerization.

In some applications, the glucose probe and the polymer precursors may be selected so that the probe molecules will not bond with the polymer precursors or the polymer matrix. Such bonding may negatively affect the detection performance or change the response mechanism, which may lead to undesired effects in some applications.

As discussed above, the polymer precursors may include one or more monomers. Monomers for forming the polymer matrix can include any suitable monomer known to persons skilled in the art, which is capable of copolymerizing with another monomer to form a copolymer. While the monomer is copolymerizable with another monomer such as the surfactant, the monomer may also be polymerizable with itself. The type and amount of the monomer that may be employed to prepare a suitable bicontinuous microemulsion can be determined by a skilled person for a given application. Exemplary monomers that may be used include ethylenically unsaturated monomers including methyl methacrylate (MMA), 2-hydroxylethyl methacrylate (HEMA), 2-hydroxylethyl acrylate, monocarboxylic acids such as acrylic acid (AA) and methacrylic acid (MA), glycidyl methacrylate (GMA), and silicone-type monomers. Suitable combinations of these monomers may also be used.

The polymer precursors may also include a polymerizable surfactant. A polymerizable surfactant is capable of polymerizing with itself or with other monomeric compounds to form a polymer. The surfactant may include any suitable surfactant that can co-polymerize with at least one of the monomer(s) in the first fluid. As can be appreciated, when the surfactant is copolymerized into the polymer, there is no need to separate the surfactant from the polymer after polymerization. In some applications, this may be advantageous as the polymer formation process is simplified. The surfactant can be anionic, non-ionic or zwitterionic. Exemplary surfactants include poly(ethylene oxide)-macromonomer (PEO-macromonomer), such as ω-methoxy poly(ethylene oxide)₄₀ undecyl α-methacrylate macromonomer denoted herein as C₁-PEO-C₁₁-MA-40. The chain length of the macromonomer can be varied. For example, the macromonomer may be in the form of CH₃—O—(CH₂CH₂O)ₓ—(CH₂)ₙV, or may be zwitterionic surfactants such as SO₃(CH₂)ₘ⁺NCHCHCHN(CH₂)ₙV, where m is an integer ranging from 1 to 20, n is an integer ranging from 6 to 20, x is an integer ranging from 10 to 110, and V is (methyl)acrylate or another copolymerisable unsaturated group.

The choice and weight ratio of the particular monomer and surfactant for a given application may depend on the application. Generally, they should be chosen such that the resulting polymer is suitable and compatible with the environment in which the polymer is to be used and has the desired properties.

The second fluid in the second phase may contain pure water or a water-based liquid. An aqueous solution may be used and, in addition to the glucose probe, may optionally contain various additives having specific properties. Such additives can be selected for achieving one or more desired properties in the resulting product, and can include one or more of a drug, a protein, an enzyme, a filler, a dye, an inorganic electrolyte, a pH adjuster, and the like. In particular, a pH adjuster may be conveniently added to adjust the pH in the resulting polymer to improve performance of the glucose probe. It has been found that the pH of the polymer can affect the performance of the glucose probe. In some embodiments, a pH of about 7 may be appropriate.

In different embodiments, the precursor solution may also include a polymerization catalyst, a cross-linker, or other additives.

The catalyst used for effecting the polymerization may be any catalyst or polymerization initiator that promotes polymerization of the selected monomers and surfactant. The specific catalyst chosen may depend on the particular monomers, and polymerizable surfactant used or the method of polymerization. For example, polymerization can be achieved by subjecting the microemulsion to ultraviolet (UV) radiation if a photo-initiator is used as a catalyst. Exemplary photo-initiators include 2,2-dimethoxy-2-phenyl acetophenone (DMPA) and dibenzylketone. A redox-initiator may also be used. Exemplary redox-initiators include ammonium persulphate and N,N,N′,N′-tetramethylethylene diamine (TMEDA). A combination of photo-initiator and redox-initiator may also be used. In this regard, including in the precursor solution an initiator can be advantageous. The polymerization initiator may be about 0.1 wt % to about 0.4 wt % of the microemulsion.

To promote cross-linking between polymer molecules in the resulting polymer, a cross-linker may be added to the precursor solution. Suitable cross-linkers include ethylene glycol dimethacrylate (EGDMA), diethylene glycol dimethacrylate and diethylene glycol diacrylate, and the like.

As can be appreciated, within a limit, the sizes of the pores can be adjusted by adjusting the volume ratio of the first phase to the second phase. The ratio of the components in the precursor solution can thus be adjusted to control the pore sizes, depending on the particular glucose probe used and the desired mechanical properties for the polymer in a particular application.

The suitable concentrations and relative proportions of different ingredients for forming a bicontinuous microemulsion may be selected in view of the principles disclosed in Chow and the references cited therein. For example, a ternary phase diagram for the monomer, water and the surfactant may be used. The addition of a dopant such as a small amount of the probe molecules in the precursor solution typically will not disrupt the separation of the two continuous phases. In any event, the formation of a bicontinuous microemulsion can be confirmed using techniques known to persons skilled in the art. For example, the conductivity of the precursor solution may increase substantially when the microemulsion is bicontinuous. The conductivity of the precursor solution may be measured using a conductivity meter after titrating a 0.1 M sodium chloride solution into the precursor solution.

In one embodiment, suitable bicontinuous microemulsions can be formed when proportions of the components are respectively from about 15 to about 50% for water, from about 5% to about 40% for the monomer, and from about 10% to about 50% for the surfactant, all percentages by weight (denoted wt % hereafter). Persons skilled in the art will understand how to combine different monomers and surfactants in different ratios to achieve the desired effect on the various properties of the resulting polymer, for example to improve the mechanical strength or hydrophilicity of the resulting polymer. Further, the ratios should be limited to those that will produce the pore structures described herein.

The polymer should be safe and biocompatible with human cells, particularly with human eyes when it is used as an ophthalmic material, such as in an ophthalmic device including contact lenses. It is desirable that the polymer is permeable to fluids such as tears, gases (e.g. O₂ and CO₂), various salts, nutrients, water and diverse other components of the tear fluid. The connected pores also facilitate the transport of components of the tears, including glucose, to different locations in the polymer, and allow them to travel deep into the polymer to interact with the glucose probe trapped inside the internal pores, thus increasing detection efficiency. The connected pores also facilitate the transport of gases, molecules, nutrients and minerals to the eye and to the surroundings. To this end, pores may be distributed throughout the polymer. Efficient transportation of tear components and other substances may be possible even when the pores have cross-sectional sizes in the range of sub-micrometer.

The glucose probe may be obtained from commercial sources or specifically designed and prepared. For example, Chalc-1 may be prepared by a condensation reaction of an aldehyde with a ketone in a Claisen-Schmidt reaction, which has been described in, e.g., March J., “Advanced Organic Chemistry”, fourth Edition, 1992, p. 940, Wiley Interscience (hereinafter “March”). Chalc-1 and Chalc-2 may also be prepared as described in Nicolas DiCesare et al., “Chalcone-analogue fluorescent probes for saccharides signaling using the boronic acid group,” Tetrahedron Letters, 2002, vol. 43, pp. 2615-2618 (hereinafter “Nicolas”).

Glucose probes may also be prepared as described in Chapoy, Geddes I, Geddes II, Kaur, Badugu I, Badugu II, or Robinson.

The amount of the glucose probe to be included in the precursor solution can be determined based on various factors. For example, for a desired probe density in the resulting polymer, the probe concentration in the precursor solution may be determined. A higher probe concentration may be used to provide a stronger detection signal. However, the solubility of the probe in the precursor solution may limit the amount of glucose probe that can be incorporated into the polymer. In general, the probe should have a concentration suitable for detecting the desired level of glucose concentration in the tear fluid, without significantly negatively affect other functions of the contact lens. For example, the transparency of the contact lens should be maintained at a suitable level. Tests show that transparent polymers can be prepared when up to about 0.1 to 0.5 wt % of boronic acid probe is added to the precursor bicontinuous microemulsion. As used herein, the term “transparent” broadly describes the degree of transparency that is acceptable for a contact lens or like devices, for example the degree of transmission of visible light through the polymer equivalent to that of other materials employed in the manufacture of contact lenses or other ophthalmic devices. The contact lens material should also allow sufficient transmission of fluorescence excitation and emission light for effective detection of fluorescence response from probe molecules trapped within the pores of contact lens 100.

Further, experiments show that the concentration of the glucose probe may affect the resulting polymer's mechanical properties. Thus, selection of the probe concentration should take this factor into consideration. Conveniently, the mechanical properties of the polymer may also be adjusted by adjusting the concentrations of other components, such as water. Thus, for a given desired probe concentration, it is possible to produce a polymer material with suitable or optimized mechanical and optical properties by adjusting, for example, water concentration, in the precursor solution.

The concentrations of the various ingredients in the precursor solution may be selected to optimize certain properties of the contact lens, such as one or more of glucose detection sensitivity, detection response time, reversibility, shelf-life, or the like.

The microemulsion may be polymerized using any suitable polymerization techniques known to those skilled in the art. For example, polymerization may be effected by heat, by the addition of a catalyst, by irradiation, by introduction of free radicals into the microemulsion, or a combination of these techniques. The polymerization initiation technique may be selected depending on the nature of the components of the microemulsion.

The microemulsion may be formed into a desired end shape and size prior to polymerization. For example, a sheet material may be formed by pouring or spreading the precursor solution into a layer of a desired thickness or by placing the precursor solution between glass plates prior to polymerization. The precursor solution may also be formed into a desired shape such as a contact lens shape or a rod-shape, for example, by pouring the precursor solution into a mold or cast prior to polymerizing.

After polymerization, the polymer may be rinsed and equilibrated with water to remove un-reacted monomers and the probe that has not been incorporated into the polymer. The rinsed polymer can be optionally dried and sterilized in preparation for use in a medical or clinical application. Both drying and sterilization can be accomplished in any suitable manner, which is known to person of skill in the art. In some embodiments, both drying and sterilization can be effected at a low temperature, for example by using ethyleneoxide gas or UV radiation.

The formed polymer has the pore structures described above with reference to polymer 102. The polymer can be conveniently made compatible with human dermal fibroblasts cells and mechanically strong. The polymer can have various desirable physical, chemical, and biochemical properties. For example, experiments have shown that the change in fluorescence response of sample polymers to glucose could be visually detected at glucose concentrations as low as about 250 μM. Sample polymers have been tested and shown to be physiologically compatible for use as contact lens materials. The synthesis process is flexible and can be adapted to conveniently adjust the mechanical and optical properties of the resulting material by, e.g., varying the water content in the precursor solutions. For example, the hydrophilicity and oxygen permeability (Dₖ) of the material may be varied from about 16 to about 24 by increasing the water content in the precursor solution; the tensile strength of the material may be varied from about 3.8 to about 5.7 MPa, by decreasing the water content in the precursor solution. The Young's modulus of the material may be varied from about 120 to about 280 MPa. The aforementioned ranges of strengths are sufficient to provide a durable contact lens product. It has also been shown that human corneal epithelial cells (HCECs) can be supported, attached, and proliferated in the sample polymers. The cells showed a healthy morphology and high viability.

The contact lenses formed from the polymer can be used as diabetic contact lenses and can be disposable, and allows non-invasive monitoring of tear glucose level in a continuous manner.

The resulting polymer can also be used to form other ophthalmic devices for detecting the presence of glucose, or used in various ophthalmic applications. For example, the polymer may be used in an implant, which is inserted into a patient's body. The glucose level in the body may thus be monitored by detecting the changes in the spectral response of the probe in the implant.

The following non-limiting examples further illustrate exemplary embodiments described herein.

### EXAMPLES

### Example I

### Preparation of Samples I, II and III

Sample precursor solutions were prepared from mixtures of water; 2-hydroxyethyl methacrylate (HEMA); methyl methacrylate (MMA); ω-methoxy poly(ethylene oxide)₄₀ undecyl α-methacrylate macromonomer (PEO-R-MA-40), as surfactant; Chalc-1, as probe; ethyleneglycol dimethacrylate (EGDMA), as crosslinker; and 2,2-dimethoxy-2-phenyl acetophenone (DMPA), as initiator.

The Chalc-1 fluorophores used in the precursor solutions were synthesized as described in J. P. Lorand and J. O. Edwards, J. Org. Chem., 1959, vol. 24, pp. 769, the entire contents of which are incorporated herein by reference. The solid Chalc1 sample was orange in color solid and had the following properties: melting point, 157-158° C.; ¹H nuclear magnetic resonance (NMR) (CD₃OD) (ppm), 3.01 (s, 6H), 6.79-8.05 (m, 10H).

The calculated results from analylical analysis of the expected molecule formula, C₁₇H₁₈BNO₃, were: C, 69.18; H, 6.15; N, 4.75. In comparison, the results measured from the sample product were: C, 68.47; H, 6.38; N, 4.53. λ_{absorption}=438 nm and λ_{fluorescence}=575 nm.

The concentrations of ingredients in different sample precursor solutions are listed in Table I. The precursor solutions formed bicontinuous microemulsions, and were polymerized in a UV reactor chamber.

The resulting sample polymeric membrane materials were molded to form contact lenses by mold-casting.

The samples formed from different precursor solutions are referred to as Samples I, II and III respective, as indicated in Table I.

TABLE I

| Content of Precursor | | | |
|---|---|---|---|
| Solution (wt %) | Sample I | Sample II | Sample III |
| Water | 25.0 | 30.0 | 35.0 |
| PEO-R-MA-40 | 37.5 | 35.0 | 32.5 |
| MMA | 18.75 | 17.5 | 16.25 |
| HEMA | 18.75 | 17.5 | 16.25 |
| EGDMA | 1.0 | 1.0 | 1.0 |
| DMPA | 0.3 | 0.3 | 0.3 |
| Chalc-1 (mg/ml) | 3 | 3 | 3 |

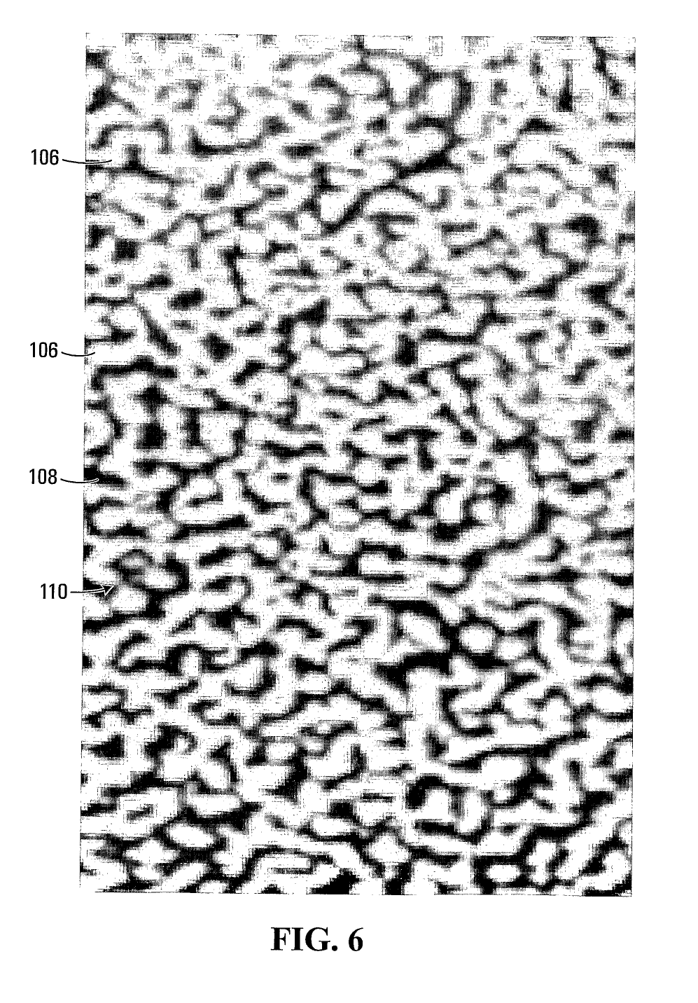

A cross-sectional electron microscopic image of a representative Sample II is shown in FIG. 6. As shown in FIG. 6, the polymer sample had the pore structures descried above. Specifically, the bright portions in FIG. 6 represent the polymer matrix (indicated as 106); the dark portions represent the pores (indicated as 108), and the narrow dark portions represent the narrow openings (indicated as 110). It can also been seen that some of the pores were connected to other pores to form a network of connected pores. Some pores were isolated from other pores. Some pores were connected to other pores only through narrow openings. The average pore size was about 20 to about 30 nm, and the sizes of the openings between pores were about 10 to about 20 nm.

### Example II

### Sample Characterization

The strain (%), Young's modulus and tensile strength of the sample polymeric membranes of Example I were measured using an Instron™ 4502 microforce tester, according to the ASTM (American Society for Testing and Materials) 638 standard. Samples were of a standard size as dictated by ASTM 638.

The oxygen permeabilities of the materials were measured by Rehder™ M201T Permeometer.

Representative results are listed in Table II.

TABLE II

| | Sample I | Sample II | Sample III |
|---|---|---|---|
| Water content in polymer (wt %) | 64 | 74 | 76 |
| Oxygen permeability | 16 | 22 | 24 |
| Tensile strength (MPa) | 5.7 | 4.7 | 3.8 |
| Young's modulus (MPa) | 280 | 195 | 120 |

### Example 111

### Cell Culture in Samples and Viability Assay

HCECs were seeded on the sample polymer membranes prepared in Example I, supplemented with a serum-free medium until confluence. The serum-free medium contained keratinocyte growth medium supplemented with 10 ng/mL human epidermal growth factor (hEGF), 5 μg/mL insulin, 0.5 μg/mL hydrocortisone, 8.4 ng/mL cholera toxin, 30 μg/mL bovine pituitary extract, 50 μg/mL gentamicin, and 50 ng/mL amphotericin B. The cells were incubated in 5% CO₂ at 37° C., with medium change performed every 2 days. The cells formed a confluent epithelial sheet on the polymer membranes after 7 days. The cell cultures were monitored under an inverted phase-contrast microscope. The viability of the cultivated cells was determined by 4′-6-diamidino-2-phenylindole (DAPI) staining. Test results showed that viable HCECs were cultured and proliferated on all tested sample polymer membranes. The cell viability was confirmed by positive staining for DAPI.

### Example IV

### Fluorescence Response

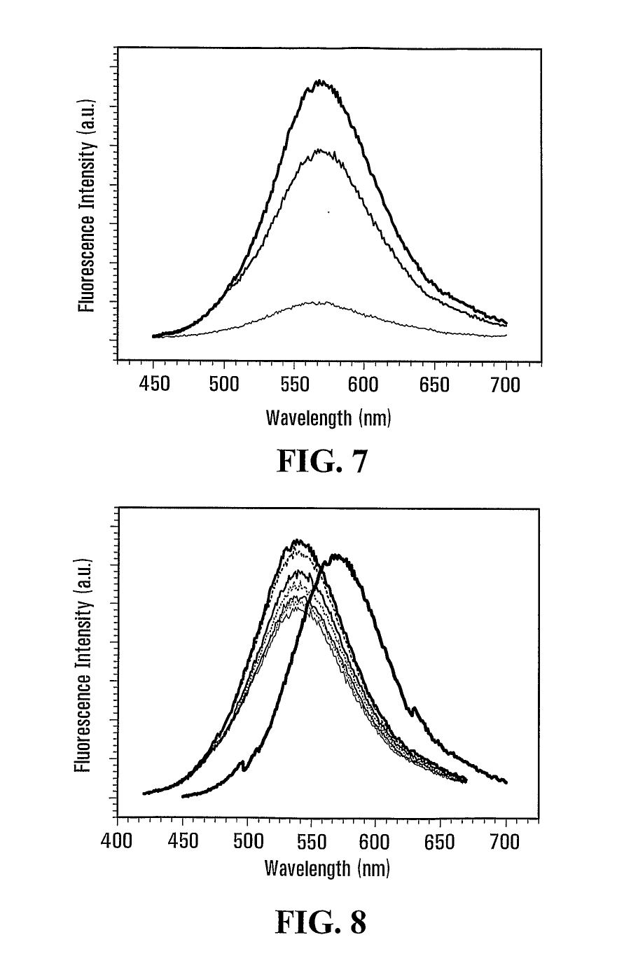

Fluorescence measurements of sample polymer membranes prepared in Example I and comparison samples were performed on a Perkin-Elmer™ LS-50B fluorometer, with a 4 cm×1 cm×1 cm quartz cuvette for holding the samples. Excitation and emission spectra were measured with a fluorometer, with the concave edge of its lens facing the excitation source. The samples were in contact with about 1.5 ml of a solution at both its front and back sides during measurement. The excitation wavelength λ_{excitation} was 430 nm. Representative results are shown in FIGS. 7, 8, and 9.

FIG. 7 shows emission spectra of Chalc-1 in (i) an aqueous solution (bottom line), (ii) a bicontinuous microemulsion containing about 25 wt % of the aqueous solution and 3 mg/ml of Chalc-1 (middle line), without polymerization, and (iii) a sample polymer prepared from the bicontinuous microemulsion by polymerization (top line), respectively. These spectra were measured in the absence of glucose.

As can be seen in FIG. 7, emission intensity was significantly enhanced by immobilizing the Chalc-1 probe in the sample polymer matrix, over both probes in the aqueous solution and in the precursor solution. Without being limited to any particular theory, the substantial increase in emission intensity may be due to rigidochromism resulted from polymerization and the consequent immobilization (restricted movement or motion) of the probe. When the molecular motion of Chalc-1 is limited, the emission intensity might be enhanced due to slower non-radiative decay processes.

FIG. 8 shows the change in emission spectrum measured from Sample I in the presence of glucose at different glucose concentrations. The spectrum line peaked at about 575 nm (on the right hand side) was for the blank solution with no glucose. The lines peaking at about 542 nm (on the left hand side) correspond to, from top to bottom respectively, glucose concentrations at 250 μM, 500 μM, 1 mM, 50 mM, 100 mM, 150 mM, and 200 mM.

As can be seen, a spectral shift of about 30 nm was induced by the presence of glucose. Emission intensity also gradually decreases with increasing glucose concentration. Without being limited to any particular theory, the observed spectral changes might be due to the excited state charge transfer (CT) associated with the change of the boronic acid species from a neutral state [R—B(OH)₂] to an anionic state [R—B(OH)₃] in the presence of glucose. This electronic change altered the electron-withdrawing property of the boron group, and thus the spectral properties of the intramolecular charge transfer (ICT) of the excited state. The blue shift could also be attributed to the rigidochromic effect since the CT excited state in the immobilized probe would be less stable as compared to that of a mobile probe in a solution where the solvent molecules could effectively rearrange themselves to stabilize the CT excited state.

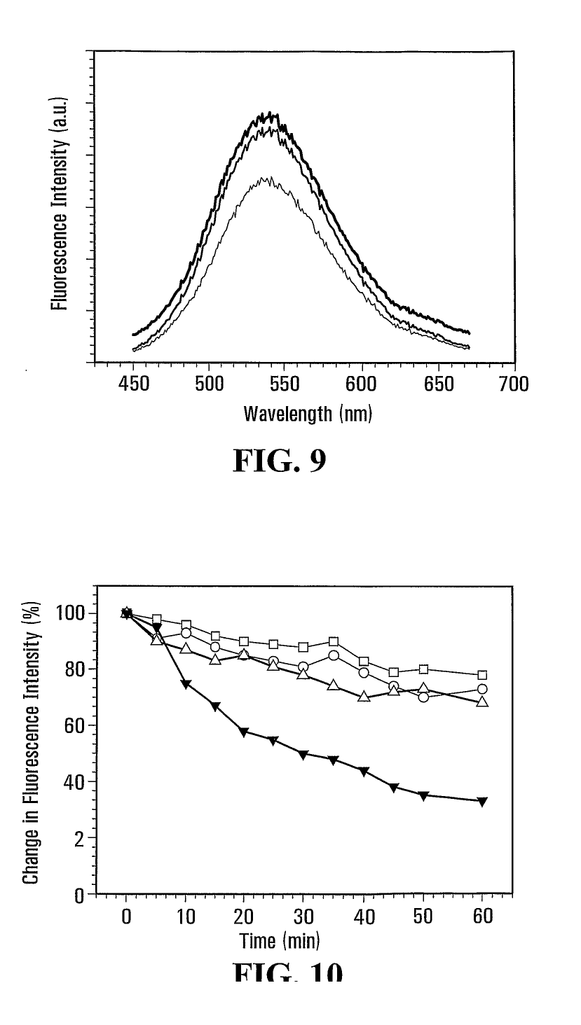

FIG. 9 shows the emission spectra measured from Samples I (top line), II (middle line), and III (bottom line) in the presence of glucose at a fixed glucose concentration of 50 mM.

As can be seen, the emission intensity of Chalc-1 probe decreases when the water content in the precursor solution for the sample was decreased from 35 to 25 wt %. This dependence is consistent with the rigidochromic effect discussed above. With a lower water content in the precursor solution, the volume ratio of the fluid conduits to polymer matrix is smaller; the environment might be thus regarded as more ‘rigid’ and therefore the emission intensity increased. Another possible reason is that with decreased water content in the precursor solution, and a consequently smaller volume ratio of fluid conduits to polymer matrix, the interfacial volume between the glucose solution and the polymer matrix became smaller.

### Example V

### Test for Leaching

Leaching of the probes in Samples I to III were tested by monitoring the changes in fluorescence response of the samples with a fluorometer while the samples were immersed in a 1.5 ml buffer at 25° C.

FIG. 10 shows the changes in fluorescence intensity over time measured from samples I (squares), II (circles) and III (hollow triangles), and a comparison sample (solid triangles) in which the Chalc-1 probe was only loaded inside the pores of a porous contact lens at a concentration of 3 mg/ml. The porous contact lens for the comparison sample was obtained from a commercial source. Probe molecules leached out of the polymer were continuously removed from the buffer solution when the florescence emission was monitored.

As a control test, the fluorescence emission intensity in a blank buffer solution (with no probe sample) was also monitored. No change or drift in fluorescence intensity was observed over time in the control test.

The decrease in emission intensity over time in these tests indicated possible leaching of Chalc-1 probe, as the probe has a lower intensity in the solution than in the polymer.

### Example VI

### Preparation of Samples IV and V

Non-ionic bicontinuous microemulsion precursor solutions were prepared from mixtures of PEO-R-MA-40, HEMA, MMA, EGDMA, DMPA, and an aqueous solution containing 0.07M of Chalc-2 as the glucose probe. For different samples, the water and monomer concentrations were varied as shown in Table III.

TABLE III

| Content of Precursor | | |
|---|---|---|
| Solution (wt %) | Sample IV | Sample V |
| Water | 25.0 | 35.0 |
| PEO-R-MA-40 | 37.5 | 32.5 |
| MMA | 18.75 | 16.25 |
| HEMA | 18.75 | 16.25 |
| EGDMA | 1.0 | 1.0 |
| DMPA | 0.3 | 0.3 |
| Chalc-2 (mg/ml) | 3 | 3 |

The Chalc-2 compound used was prepared according to the procedure described in Nicolas. The prepared Chlac2 compound (M/Z 378.2) was a dark orange-red solid (40%), with the following properties: m.p., 266-267° C.; ¹H NMR (CD₃OD) δ (ppm): 3.05 (s, 6H), 6.78-7.92 (m, 12H), λ_{abs}=445 nm and λ_{F}=663 nm.

The polymer precursors in the precursor solution were polymerized by subjecting the precursor solution to UV light irradiation in a UV reactor chamber. Contact lenses were formed from the resulting polymer by molding.

The Samples as prepared are referred to as Samples IV and V respectively, depending on the precursor solution content as indicated in Table III.

The tensile strength and oxygen permeability of the sample lenses were measured in triplicates by a Dynamic Mechanical Analyzer (TA Instruments, DMA 2980) and a Model 201T Permeometer (Rehder, M201T).

The sample lenses were transparent and had oxygen permeability (Dₖ) of about 20. The tensile strengths of the sample materials varied from 1.2 (Sample V) to 8.8 MPa (Sample IV).

### Example VII

### Fluorescence and Leaching of Samples IV and V

Steady-state fluorescent spectra from Samples IV and V were recorded on a Perkin-Elmer LS-50B fluorespectrometer, equipped with a 7.3 W pulsed Xenon discharge lamp, average power at 50 Hz, at an excitation wavelength of 445 nm in the presence of glucose at different concentrations from 0.01 to 5 ppm.

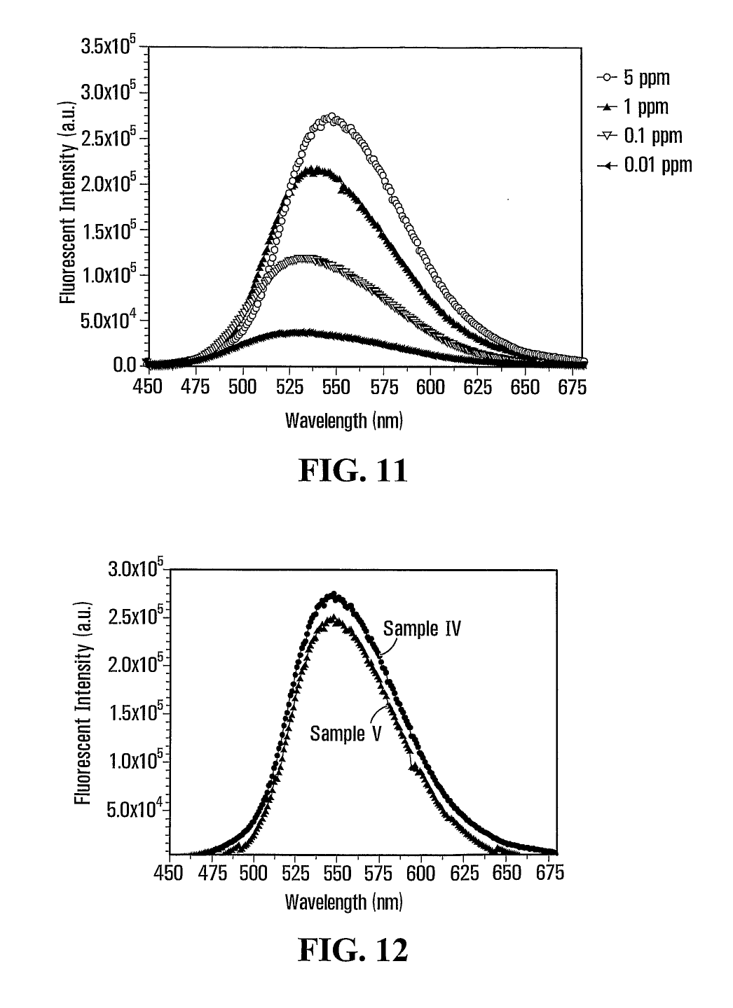

Representative results are shown in FIGS. 11 and 12. FIG. 11 shows emission spectra obtained from Sample IV at different glucose concentration levels as indicated. The pH of the test solution was 7. FIG. 12 shows the fluorescence intensity in spectral responses obtained from Samples IV and V respectively at glucose concentration of 5 ppm. The fluorescence intensity was lower in Sample V than in Sample IV.

Samples IV and V exhibited an enhancement in fluorescence intensity with a blue shift in energy (shift of about 25 nm) with different glucose concentration, as compared to Chalc-2 probes dispersed in solutions.

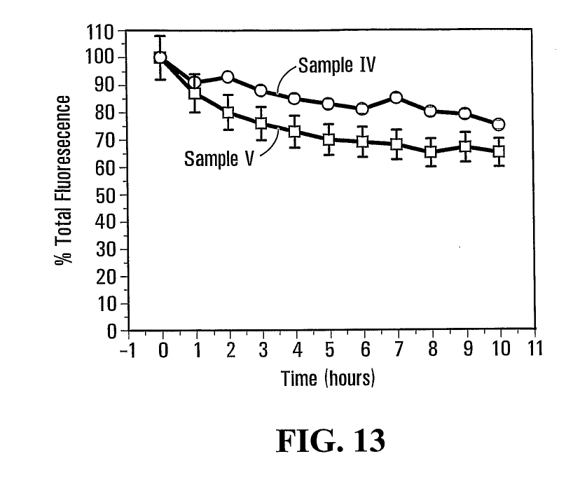

Leaching of the probe in Samples IV and V was determined by emission intensity measurements on leached probe in the releasing medium (5 ppm glucose solution) at different times. Representative results are shown in FIG. 13. As can be seen, the Samples exhibited strong emission intensity even after 10 hours in the solution, indicating that a large portion of the probe molecules were trapped and immobilized in the pores of the polymer. Even though many pores in the polymer were interconnected, the probe molecules were apparently unable to leach out from the pores, indicating that they were blocked by the dead ends or narrow openings that connected the pores.

### Example VIII

### Biocompatibility of Samples IV and V

Primary human corneal epithelial cells (HCE) were cultured onto the sample lenses formed from Sample IV and V in supplemented Dulbecco's Modified Eagle's Medium (DMEM, 10% fetal bovine serum, 2 mM L-glutamate, 100 units/mL of penicillin and 100 μg/mL of streptomycin) (GibcoBRL). The cell-loaded lenses were incubated at 37° C. in a humidified atmosphere with 5% CO₂. The morphology of the cells was monitored and photographed under a phase-contrast microscopy (AVIOVERT, ZEISS, Germany) and equipped with a camera (Nikon 4500). The corneal epithelial cells were seeded onto the samples at a density of 15,000 cells/mL in the culture medium.

The sample lens materials were found to be biocompatible with the cultured cells.

Where a list of items is provided with an “or” before the last item herein, any one of the items may be used; and a possible combination of any two or more of the listed items may also be used, as long as the combined items are not inherently incompatible or exclusive.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

1. A method of forming a polymer for use in an ophthalmic device, comprising:
polymerizing polymer precursors in a precursor solution comprising a bicontinuous microemulsion of a first fluid in a first continuous phase comprising said polymer precursors and a second fluid in a second continuous phase, to form a polymer matrix defining internal pores and surface pores, a plurality of said internal pores connected to surface pores through openings sized to allow passage of glucose molecules but restrict passage of a glucose probe; and
dispersing molecules of said glucose-probe in said second fluid prior to said polymerizing, thus, after said polymerizing, trapping a portion of said glucose-probe molecules in said internal pores.

2. The method of claim 1, wherein said internal pores have an average pore size from about 20 to about 80 nm.

3. The method of claim 1, wherein said openings are from about 5 to about 10 nm in size.

4. The method of claim 1, wherein said glucose probe comprises a boronic acid.

5. The method of claim 4, wherein said boronic acid has the formula of R—B(OH)₂, where R is one of alkyl, alkenyl, cycloalkyl, cycloalkenyl, alkoxyalkyl, alkoxyalkenyl, and aryl arylakyl.

6. The method of claim 4, wherein said boronic acid comprises 1,3-diphenylprop-2-en-1-one or 1,5-diphenylpenta-2,4-dien-1-one.

7. The method of claim 6, wherein said boronic acid has a concentration of about 0.1 to about 5 wt % in said second fluid.

8. The method of claim 1, wherein said polymer precursors comprise a monomer and a surfactant copolymerizable with said monomer to form said polymer matrix, and said second fluid comprises water.

9. A polymer for use in an ophthalmic device, comprising:
a polymer matrix defining internal pores and surface pores, a plurality of said internal pores connected to surface pores through openings sized to allow passage of glucose molecules but restrict passage of a glucose probe; and
molecules of said glucose probe, trapped inside said internal pores and in a sufficient amount for generating a detectable spectral response when said polymer is in contact with an ocular fluid,
wherein said pores defined by said polymer matrix have an average pore size from about 20 to about 80 nm.

10. The polymer of claim 9, wherein said openings are from about 5 to about 10 nm in size.

11. The polymer of claim 9, wherein said glucose probe comprises a boronic acid.

12. The polymer of claim 11, wherein said boronic acid has the formula of R—B(OH)₂, where R is one of alkyl, alkenyl, cycloalkyl, cycloalkenyl, alkoxyalkyl, alkoxyalkenyl, and aryl arylakyl.

13. The polymer of claim 11, wherein said boronic acid comprises 1,3-diphenylprop-2-en-1-one or 1,5-diphenylpenta-2,4-dien-1-one.

14. The polymer of claim 13, wherein said boronic acid has a density of about 0.1 to about 5 wt % in said polymer.

15. An ophthalmic device comprising a polymer formed according to the method of claim 1, wherein the pores of said polymer have an average pore size from about 20 to about 80 nm.

16. An ophthalmic device comprising the polymer of claim 9.

17. The ophthalmic device of claim 15, comprising a contact lens.

18. A precursor solution for forming a polymer, comprising:
a bicontinuous microemulsion of a first fluid in a first continuous phase and a second fluid in a second continuous phase, said first fluid comprising polymer precursors polymerizable to form a polymer matrix, said second fluid comprising a glucose probe,
said bicontinuous microemulsion being selected so that upon polymerization of said polymer precursors, the polymer matrix formed from said precursor solution defines internal pores and surface pores, and molecules of said glucose probe are trapped in said internal pores connected to surface pores through openings sized to allow passage of glucose molecules but restrict passage of said molecules of said glucose probe therethrough.
